(19) United States
(12) Patent Application Publication
(10) Pub. No.: US 2020/0157002 A1
(43) Pub. Date: May 21, 2020

(54) Conductive Cementitious Material

(71) Applicant: George Clayton Hansen, Midway, UT (US)

(72) Inventor: George Clayton Hansen, Midway, UT (US)

(21) Appl. No.: 16/684,545

(22) Filed: Nov. 14, 2019

Related U.S. Application Data
(60) Provisional application No. 62/768,747, filed on Nov. 16, 2018.

(51) Int. Cl. C04B 20/10; C04B 20/00

(52) U.S. Cl. CPC C04B 20/1062; C04B 2103/0013; C04B 20/0048

(57) ABSTRACT

A conductive cementitious material is disclosed that may be applied by conventional techniques. The conductive cementitious material has a plurality of metal-coated fibers precision chopped to longer lengths and a cementitious material base. The metal-coated fibers are dispersed throughout the cementitious material base to create a complex electron transport system facilitating conductivity sufficient to meet or exceed desired thresholds of conductivity. The complex electron transport system created facilitates conductivity with lower loadings. The additional unloaded portion of cementitious material base may receive other multifunctional materials. Exemplary conductive cementitious materials provide controlled heating of the cementitious material by applying an electrical current.

### RELATED APPLICATION

This patent application claims the benefit of U.S. Provisional Patent Application, Ser. No. 62/768,747 that was filed on Nov. 16, 2018, for an invention titled CONDUCTIVE CEMENTITIOUS MATERIAL, which is hereby incorporated herein by this reference.

### BACKGROUND OF THE INVENTION

### 1. Field of the Invention

The present invention relates to conductive cementitious materials and the methods for preparing such materials. More specifically, the present invention relates to the component(s) and method for adding the component(s) into a cementitious material to make the material conductive.

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “some embodiments,” “various embodiments,” and the like, may indicate that the embodiment(s) of the invention so described may include a particular structure, feature, property, or characteristic, but not every embodiment necessarily includes the particular structure, feature, property, or characteristic. Further, repeated use of the phrase “in one embodiment,” or “in an exemplary embodiment,” does not necessarily refer to the same embodiment, although they may.

### 2. The Relevant Technology

In general, cementitious materials are any of various building materials which may be mixed with a liquid, such as water, to form a plastic paste, and to which an aggregate and/or other additives may be added. Cementitious materials include cements, limes, stuccos, grout, coatings, underlayment, waterproofing, fireproofing, mortar, and the like. Cementitious materials generally are formed into primary structures, or alternatively, are used as surface treatments such as stucco, plaster, or self-leveling concrete.

Again, generally, cementitious materials are those where one of the principal ingredients that make up the concrete mixture comprise a hydraulic cement and/or supplementary cementitious materials (SCMs).

Hydraulic cements set and harden by reacting chemically with water. During the reaction, which is called hydration, heat is given off as the water-cement paste hardens and binds the aggregate particles together. Portland cement is the most common hydraulic cement.

Polymers are often added to cementitious materials to improve their workability and mechanical properties. The polymer may be added in addition to or in lieu of water.

SCMs may be used in conjunction with portland cement in concrete mixtures to improve the workability of fresh concrete and reduce thermal cracking in massive structures by reducing heat of hydration. SCMs are widely used in concrete either in blended cements or added separately in the concrete mixer. The use of SCMs such as pozzolanic materials, whether natural pozzolanas such as volcanic ashes, pumices, and zeolites or industrial by-products such as blast-furnace slag (a byproduct from pig iron production), fly ash (a byproduct of coal-fired power plants), metakaolin (thermally activated kaolin-clays), silica fume (a byproduct from silicon smelting) and burned organic matter residues rich in silica such as rice husk ash. It should be noted that pozzolans are a broad class of siliceous or siliceous and aluminous materials which, in themselves, possess little or no cementitious value but which will, in finely divided form and in the presence of water, react chemically with calcium hydroxide at ordinary temperature to form compounds possessing cementitious properties.

Cementitious materials, particularly concrete, stucco, mortar, grout, and the like have been used for many years. Improved cementitious materials have been developed over recent decades. Products such as engineered cementitious composite (popularly known as bendable concrete), fiber cement siding (such as Hardie board or shingles), cement grout, self-leveling underlayments, and many more cementitious developments are gaining more and more acceptance as improved building materials.

Although electrical conductivity of concrete and other cementitious materials is of interest, reliably conductive cementitious materials that exhibit desired levels of conductivity throughout the material have not been demonstrated. Concrete is a heterogeneous mixture with an interconnected pore network. Depending on the degree of saturation of the pores (i.e., the moisture content), concrete might exhibit conductive characteristics.

Over the years, efforts to design concrete mixes capable of conducting electricity for various applications such as electrical grounding, protecting against lightning, eliminating static electricity, environmental heating, cathodic protection, thermoelectric energy generation, radio frequency interference screening, and electromagnetic interference shielding have achieved varying degrees of success.

There are many problems to be overcome in designing conductive concretes. The electrical characteristics of the finished product must be made suitable for the particular application without degrading the mechanical properties of the concrete. Typically, conductive concrete is a cement-based composite that contains electrically conductive components to attain stable and relatively high conductivity.

Exemplary potential applications include, but are not limited to, electrostatic dissipation, electrostatic discharge (ESD), electromagnetic shielding against electromagnetic interference (EMI), electrical heating for de-icing of parking garages, sidewalks, driveways, highways, highway bridges, and airport runways. In one example of conductive concrete, its ingredients differ from standard concrete by adding twenty percent (20%) of steel shavings and carbon particles as additives which give the mix enough conductivity that it can melt ice and snow while remaining safe to the touch. In yet another example, using a conductive aggregate in place of conventional aggregates; specifically, a carbonaceous aggregate that is more effective than carbon powders, achieves better conductivity because it does not cause excessive water-cement ratios.

In recent years, adding a combination of magnetite and steel rods (e.g., small nails or wires) and iron filings has gained favor for shielding and bridge de-icing. However, this technique is very expensive and requires thick walls (e.g., 12 inches thick) to accomplish the intended purpose.

Although there are examples of advances in conductivity of cementitious materials and products in recent decades, the state of art remains inadequate to meet the current needs of the marketplace. Accordingly, a need exists for more efficient, cost-effective, efficacious cementitious materials with reliable and controllable conductivity. Such cementitious materials are disclosed herein.

### SUMMARY OF THE INVENTION

The present disclosure describes developments responsive to the present state of the art and responsive to the problems and needs in the art that have not yet been fully solved by currently available cementitious materials. The conductive cementitious materials and products of the present disclosure are easily implemented and provide significant advances in efficiency, cost-effectiveness and efficacy. These conductive cementitious materials may be used in a broad range of situations requiring certain desired conductivity.

Exemplary embodiments of conductive cementitious materials of the present disclosure comprise two basic components; namely, 1) Long. Precision Chopped Fiber (LCF); and 2) a cementitious material base. By varying the amount and types of these two basic components, a cementitious material with desired and reliable conductivity may be achieved with low cost and low loading, efficaciously and efficiently.

For purposes of this disclosure, LCF is a metal-coated fiber (such as a nickel-coated fiber) chopped to a longer, specific length requirement so that when added to a cementitious material base, each product comprising such cementitious material may be applied by whatever methods are normally used to apply the product. The LCF may comprise any type of fibrous substrate, such as, for example, carbon fiber, cellulose fiber, cotton fiber, natural fibers, Kevlar, rayon, synthetic fibers, and nanofibers may be coated with a known conductive metal, including but not limited to nickel, aluminum, copper, silver, and gold. Exemplary LCF is chopped to lengths of 0.125 inches to 0.50 inches. Exemplary nickel-coated carbon fiber LCF may have a carbon fiber having a diameter of 4 to 7 microns and a nickel coating of ranging from 15% to 50% by weight, and precision chopped to a length from 0.125 inches to 0.50 inches and loaded into the cementitious material base to 0.01% to 2% by weight. A further exemplary nickel-coated carbon fiber LCF may have a carbon fiber having a nickel coating of 20% by weight, and precision chopped to a length of 0.25 inches and loaded to 0.125% to 0.25% by weight.

The LCF has been developed and produced by and is available from Conductive Composites Company of Heber City, Utah.

The cementitious material base may be water-based or polymer-based. The type of cementitious material base selected for a desired purpose will carry a load content of the LCF to achieve the desired conductivity. The LCF and cementitious material base selected work together to create a comprehensive network of electron transport pathways. The high conductivity and high aspect ratio of LCF and the dielectric properties of the cementitious material base selected facilitates and improves the inter-fiber electron transport within the cementitious material volume. The LCF act much like logs being elongated linear electron transport conduits and connect with the interconnected pore network in the cementitious material base selected.

By using Long, Precision-Chopped Fiber (LCF) dispersed throughout the cementitious material base, desired conductivity within a full range of 10⁸ to 10⁻³ ohm-cm (for example, 10⁷ to 10⁴ ohm-cm for ESD and 10¹ to 10⁻² ohm-cm for shielding against EMI) may be achieved while maintaining lower loads (ranging between 0.01% to 2% by weight) than known conductive cementitious materials.

Because the newly required thresholds for desired conductivity can be achieved at lower loads and less expensively, within many different types of conductive cementitious material of the present disclosure, such materials may have robust functionality and applicability. Other functional particles may be loaded as additives giving the conductive cementitious material other functions. By way of example only, and not to be construed as limiting, additives such as coloring particles, hardening agents such as silicon carbide, lubricating agents, and magnetic particles have room in the matrix to be added to the extent that they do not functionally reduce the desired conductivity. Hence, colors of such cementitious materials now may be achieved across a broader spectrum of colors and may be more vibrant. The cementitious materials may harden faster and exhibit greater hardness or wear-resistance. Further functionality may be exhibited by having different functions in different layers of a cementitious coating. Also, other desirable functions now may be exhibited in the cementitious material without functionally sacrificing the needed conductivity.

Interrelated methods are used to achieve a desired conductivity that will cause the cementitious material to manifest the desired conductivity. Those skilled in the art of electron transport through materials, armed with this disclosure, intuitively and readily can determine the interrelationships of the components to achieve the desired conductivity to be exhibited by the cementitious materials through known empirical means, and without undue experimentation.

The most basic parameters fall into the combination of three categories; 1) the fiber properties of the LCF; including length, diameter, the type of metal coating, and coating thickness; 2) the loading level of the LCF within the cementitious material; and 3) the dielectric properties of the cementitious material base.

By matching the interplay of the fiber properties of the LCF with dielectric properties of the cementitious material base, the load ratio of LCF to the cementitious material base to achieve a minimum threshold for the desired amount of conductivity may be determined for whatever type of product that cementitious material is used within the product. Generally, LCF may be added to increase conductivity to achieve more robust conductivity.

The interrelation of the LCF—metal content (e.g., nickel) and fiber length, when considered with the dielectric properties of the cementitious material base creates a highly complex electron transport system which is difficult to model; however, the electron transport system may be standardly optimized by those skilled in the art through empirical derivation.

As an exemplary sample, LCF of 6 mm length having a nickel coating 20% by weight and dispersed throughout a cementitious material; namely, self-leveling concrete to a load level between 0.125% to 0.25% has been demonstrated to provide desired ESD. Also, ESD may be provided at broader load levels between 0.05% to 0.5%. Similarly, LCF of 6 mm length having a nickel coating 20% by weight and dispersed throughout a cementitious material; namely, self-leveling concrete to a load level between from 1% to 2% has been demonstrated to provide shielding against EMI. Using the same parameters, similar results have been observed in both plaster and stucco.

In another exemplary embodiment, LCF of 6 mm length having a nickel coating 20% by weight dispersed within self-leveling concrete to a load level of 1% to 2% yields an overlayment to which a current (12 volts at 1 amp) is applied. As a result, the temperature of the overlayment increased from 25° C. to 50° C. in five minutes. Thereafter, the temperature remained at a constant temperature of 50° C. Hence, those skilled in the art, armed with this disclosure, may resistivity engineer conductive cementitious materials as disclosed herein to achieve a desired temperature with the application of a current.

These and other features of the exemplary embodiments of the present invention will become more fully apparent from the drawings and the following description, or may be learned by the practice of the invention as set forth hereinafter.

### BRIEF DESCRIPTION OF THE DRAWINGS

The exemplary embodiments of the present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are representative and are provided so that this disclosure will be operative, enabling, and complete. Accordingly, the particular arrangements disclosed are meant to be illustrative only and not limiting the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list. Additionally, the terms “operator”, “user”, and “individual” may be used interchangeably herein unless otherwise made clear from the context of the description.

Understanding that these drawings depict only typical, representative exemplary embodiments of the invention and are not therefore to be considered to be limiting of its scope, the invention will be described and explained with additional specificity and detail through the use of the accompanying drawings in which:

FIG. 1 is a perspective view of an exemplary embodiment of a long, precision-chopped fiber with a portion of the metal coating removed to reveal the fiber;

FIG. 2 is an end view of the exemplary long, precision-chopped fiber of FIG. 1 showing that the coating encircles the fiber;

FIG. 3 is a perspective view of an exemplary embodiment of another long, precision-chopped fiber with a portion of a thinner metal coating removed to reveal the fiber;

FIG. 4 is an end view of the exemplary long, precision-chopped fiber of FIG. 3 showing that the thinner coating encircles the fiber;

FIG. 5 is a representative cross-sectional view of a portion of an exemplary embodiment of a cementitious material, the texture depicted represents structure of all exemplary cementitious materials;

FIG. 6 is a representative cross-sectional view of a portion of another exemplary embodiment showing LCF dispersed throughout the exemplary cementitious material of FIG. 5;

FIG. 7 is a representative cross-sectional view of a portion of still another exemplary embodiment showing LCF dispersed throughout the exemplary cementitious material of FIG. 5 and with a single multifunctional additive also dispersed therein; and,

FIG. 8 is a representative cross-sectional view of a portion of yet another exemplary embodiment showing LCF dispersed throughout the exemplary cementitious materials of FIG. 5 and with multifunctional additives also dispersed therein.

REFERENCE NUMERALS

| | |
|---|---|
| system 10 | long, precision-chopped fiber(s) or |
| | LCF 12 |
| metal coating or nickel coating 14 | fiber(s) 16 |
| cementitious base 18 | conductive cementitious material(s) |
| | 20 |
| electron transport pathway(s) 22 | functional additive(s) 24 |
| first additive 26 | second additive 28 |

### DETAILED DESCRIPTION OF THE INVENTION

The exemplary embodiments of the present disclosure will be best understood by reference to the drawings, wherein like parts are designated by like numerals throughout. It will be readily understood that the components of the exemplary embodiments of the present invention, as generally described and illustrated in the figures herein, could be arranged and designed in a wide variety of different configurations. Thus, the following more detailed description of the exemplary embodiments, as represented in the Figures, is not intended to limit the scope of the invention, as claimed, but is merely representative of exemplary embodiments of the disclosure.

Herein, the acronym “LCF” means long, precision-chopped fiber or long-cut chopped fiber. Precision-chopped fiber includes fibers chopped to long, precise 0.125 inch to 0.50 inch lengths, and may be coated or non-coated. LCF is an off-the shelf product available from Conductive Composites Company, but may also be obtained from any number of fiber converters such as Engineered Fiber Technology, LLC in Shelton, Conn.

The term “organic” refers to a class of chemical compounds that includes those existing in or derived from plants or animals and also includes compounds of carbon.

This detailed description, with reference to the drawings, describes a system 10 of components (see FIGS. 6-8) used in exemplary embodiments and the methodology for controlling what properties are manifested in various cementitious materials so that other functional additives may be inserted.

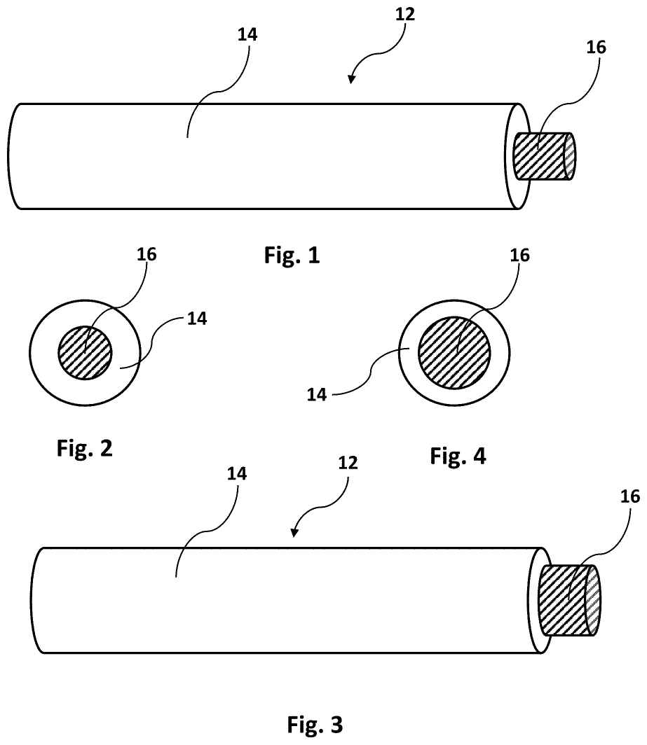

Turning to FIG. 1, an exemplary embodiment of a single, long, precision-chopped fiber 12 (“LCF”) has a metal coating 14 enclosing a fiber 16 is shown. FIG. 1 is a schematic depiction (not drawn to scale, but exaggerating the dimensions so that the basic structure may be better understood) of a single LCF 12 with a portion of the metal coating 14 removed to reveal the fiber 16. Exemplary LCF 12 is precision chopped to lengths of 0.125 inches to 0.50 inches so that when added to a cementitious material, the cementitious material may be applied and/or implemented using conventional techniques. The fiber 16 of the LCF 12 may comprise any type of fibrous substrate, such as, for example, carbon fiber, cellulose fiber, cotton fiber, natural fibers, Kevlar, rayon, synthetic fibers, and nanofibers. This list of fibrous substrates is not intended to be exhaustive. Those skilled in the art are aware and may become aware of other fibrous substrates that may be used. Such additional substrates are contemplated to fall within the scope of this disclosure.

As one example, carbon fiber 16 may be used, and because carbon has conductivity it offers some properties not available by using non-conductive fibers 16 as the substrate. Other types of fibers 16 have other characteristics that may bring other desired properties to a cementitious material. An exemplary fiber 16 may have a diameter of 3 to 7 microns.

FIG. 2 shows the metal coating 14 encircling the fiber 16. The fiber 16 may be coated with a known conductive metal, including but not limited to nickel, aluminum, copper, silver, and gold. This list of conductive metals is not intended to be exhaustive. Those skilled in the art are aware and may become aware of other conductive metals or alloys thereof that may be used. Such additional metals or alloys thereof are contemplated to fall within the scope of this disclosure.

An example thickness of a metal coating, depending on the type, diameter, and length of the fiber 16 and the type of metal coating, may be where the metal coating 16 ranges from about 15% to about 50% of the LCF 12 by weight.

In one preferred embodiment, an exemplary nickel-coated carbon fiber LCF 12 may have a carbon fiber 16 having a diameter of 4 to 7 microns and a nickel coating of 20% by weight, and preferably is precision chopped to a length from 0.125 inches to 0.50 inches.

Conductivity evolves from the onset of establishing an electrical percolation network. Consequently, the onset of an electrical percolation is particularly important for low conductivity applications, such as electrostatic dissipation and electrostatic discharge. To that end, a unit weight of fiber with less nickel coating will yield more length of fiber per unit weight. Thus, for the same fiber loading into the system 10 matrix, a 20% nickel-coated fiber 16 will establish percolation at loadings lower than a 40% nickel-coated fiber 16, making 20% fiber particularly suitable for electrostatic dissipation and electrostatic discharge applications. It has been determined that electrostatic discharge is best established using 20% fiber at lengths precision chopped to 0.5 millimeters or greater.

FIGS. 3 and 4 depict an exemplary embodiment of another long, precision-chopped fiber 12 with a portion of the metal coating 14 removed to reveal the fiber 16. When compared to FIGS. 1 and 2, FIGS. 3 and 4 show a long, precision-chopped 12 having a thinner metal coating 14 and a fiber 16 having a larger diameter than the long, precision-chopped fiber 12 depicted in FIGS. 1 and 2. The demonstration of the relative difference between the two, depicted long, precision-chopped fiber 12 demonstrates that the percent-by-weight of the metal coating 14 may be adjusted by 1) increasing or decreasing the thickness of the metal coating 14 for a given metal and a given LCF 12 length; and/or 2) increasing or decreasing the diameter of the fiber 16 for a given fiber and a given LCF 12 length. This adjustability, taken together with the loading range of the LCF 12 within a given cementitious material, gives a person of ordinary skill in the art the ability to fine tune the level of conductivity desired for the cementitious material.

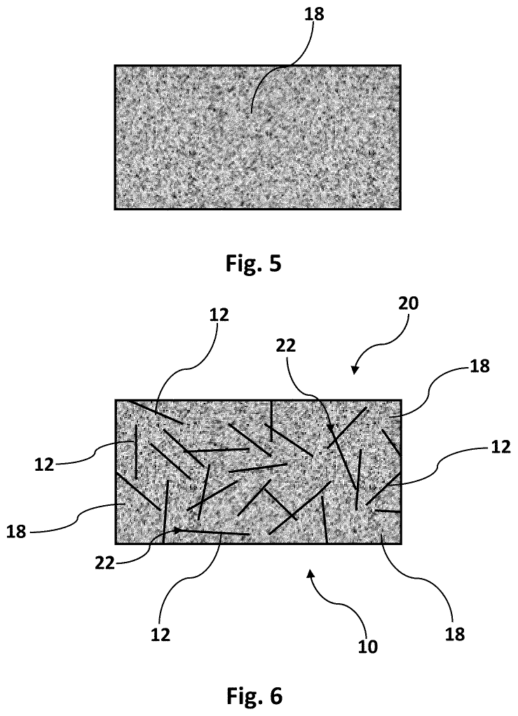

FIG. 5 is a representative cross-sectional end view of a portion of an exemplary embodiment of a cementitious base 18 for an electrically conductive cementitious material 20. Cementitious material 20 products are made and worked with a wide range of viscosity, types of principal ingredients (hydraulic cement or SCMs), and other variables and characteristics. In each exemplary embodiment of the system 10, the conductivity is determined as a function of the cementitious base 18 type.

FIG. 6 is a representative cross-sectional view of a portion of an exemplary embodiment showing LCF 12 dispersed throughout the exemplary cementitious base 18 of FIG. 5. In the present state of the art, conductive cementitious bases 18 are heavily loaded with carbon or steel shavings to introduce conductivity. Because known conductive cementitious materials are so heavily loaded to achieve conductivity, viscosity is high and loading other additives is precluded or severely limited. Also, cementitious materials having electrostatic discharge or shielding capability that use the present state of the art, are expensive, complex to make, difficult to replicate and control, thick, difficult to work, and unable to receive other functional additive loading.

However, the system 10 of the present disclosure provides more efficient, cost-effective, efficacious electrically conductive cementitious material 20 with a range of electromagnetic properties, controllable conductivity, flowable viscosity, easy to replicate, and have multifunctional capabilities while providing desired electromagnetic properties. Introducing a dispersal of LCF 12 into the cementitious base 18, as shown in FIG. 5, yields an electrically conductive cementitious material 20 having desired electromagnetic properties over a full electromagnetic range (10⁸ to 10⁻³ ohm-cms), including electrostatic dissipation, electrostatic discharge, and shielding with lower loadings of LCF 12 that reduces viscosity and the additional unloaded portion of the electrically conductive cementitious material 20 may now receive other multifunctional materials.

The LCF 12 is distinguishable from random-chopped fibers and milled fibers that are known and used in the art. By their very nature, random-chopped fibers and milled fibers have an excessively broad distribution of fiber lengths. The use of random-chopped fibers and milled fibers have significant drawbacks including high loading to achieve desired conductivity, high viscosity, and constrained percolation. By using LCF 12, better percolation and replicable conductivity, and lower and more controllable viscosity and loading is achieved across the desired range of electromagnetic properties (10⁸ to 10⁻³ ohm-cms).

Exemplary embodiments of the electrically conductive cementitious materials 20 of the present disclosure may comprise two basic components; namely, 1) long, precision-chopped fiber (LCF) 12; and 2) a cementitious base 18. By varying the amount and types of these principal components, desired electromagnetic properties may be achieved and replicated in low cost, low loading, and low viscosity, efficacious cementitious materials 20 produced efficiently. For exemplary embodiments, the use of LCF 12 dispersed within the cementitious base 18 may achieve a desired electromagnetic property for a desired purpose or application.

FIG. 6 is a representative cross-sectional view of a portion of an exemplary embodiment showing LCF 12 dispersed throughout the exemplary cementitious base 18 of FIG. 5. The most basic parameters fall into the combination of two categories; 1) the fiber properties of the LCF 12; including length, diameter and metal coating 14 thickness; and 2) the dielectric properties of the cementitious base 18.

The cementitious base 18 may be water-borne or solvent-borne, one-part or two-part. The type of cementitious base 18 may be selected for a desired purpose and will carry a load content of the LCF 12 that may be fine-tuned so that it achieves a desired electromagnetic property such as electrostatic dissipation, electrostatic discharge, or shielding. The LCF 12 works together with the cementitious base 18 to create a comprehensive network of electron transport pathways 22. It should be understood that the electron transport pathways 22 that are created do not require the LCF 12 to touch each other. They need only be sufficiently proximate to each other to transport electrons (acting much like an antennae). (Consequently, exemplary electron transport pathways 22 are identified in the drawings by a reference arrow directed to the end of a single LCF 12. However, it should be understood that any number of pathways 22 may pass through a given LCF 22.)

The physical nature of LCF 12 facilitates the inter-fiber electron transport within the cementitious base 18 volume. The LCF 12 act much like logs being elongated linear electron transport conduits that electrically interconnect the logs. For exemplary embodiments, the use of LCF 12 dispersed within a cementitious base 18 may achieve a replicable, desired electromagnetic property for a desired purpose or application. By fine-tuning the LCF 12 length, diameter, coating thickness and types of metal used in the metal coating 14, the loading of LCF 12 into various cementitious bases 18 may be reduced, reducing cost, viscosity, and providing more space for multifunctional additives.

By matching the interplay of the fiber properties of the LCF 12 with dielectric properties of the cementitious base 18, the load ratio of LCF 12 to cementitious base 18 to achieve electrostatic discharge may be determined and fine-tuned for that metal coating 14 and cementitious base 18. Generally, LCF 12 may be added to increase conductivity to achieve a full range of desired electromagnetic properties (10⁸ to 10⁻³ ohm-cms) having more robust functionality capabilities.

The interrelation of the LCF 12—metal (nickel) content, fiber 16 diameter, and fiber 16 length, diameter, and metal coating 14 thickness, provides the capability to load to a desired conductivity. When additionally considered with the dielectric and polar properties of the cementitious base 18, the combination of LCF 12 and cementitious base 18 creates a highly complex electron transport system (i.e., a network of many electron transport pathways 22) which is difficult to model; however, the electron transport system may be standardly optimized and replicated by those skilled in the art through empirical derivation.

A known quantity of a certain LCF 12 (fiber diameter, length, metal (nickel) content) may demonstrate more or less conductivity through increasing or decreasing the thickness of the metal coating 14 and/or the length of the LCF 12. Consequently, the loading percentage of LCF 12 may be reduced significantly because of the increased conductivity of the LCF 12 as dispersed in a particular cementitious base 18. Therefore, the balance of the quantity and type of LCF 12 with the type of cementitious base 18 may be used to engineer and control the desired viscosity, electrical conductivity, and functionality.

By using fine-tuned LCF 12 dispersed uniformly within a cementitious base 18, desired electromagnetic properties (for example, a full range including electrostatic dissipation, electrostatic discharge, and shielding with volume resistivity ranging from 10⁸ to 10⁻³ ohm-cm) may be achieved and replicated while maintaining lower loads and therefore lower viscosity than known conductive cementitious materials.

Also, because the desired electromagnetic properties, such as electrostatic dissipation, electrostatic discharge, and shielding, can be achieved and replicated at lower loads and lower viscosity, the exemplary cementitious materials 20 of the present disclosure may have robust functionality. Other particles may be loaded as functional additives 24 giving the cementitious materials 20 other functions. By way of example only, and not to be construed as limiting, functional additives 24 such as coloring particles, hardening agents such as silicon carbide, lubricating agents, magnetic particles, and other known additives have room in the matrix to be added to the extent that they do not functionally reduce the desired conductivity. Hence, colors of such cementitious materials 20 now may be achieved across a broader spectrum of colors and may be more vibrant. The cementitious materials 20 may harden faster and exhibit greater hardness and wear resistance. Further functionality may be exhibited by having different functions in different layers of the cementitious materials 20. Also, other desirable functions now may be exhibited in the cementitious materials 20 without functionally sacrificing the needed conductivity.

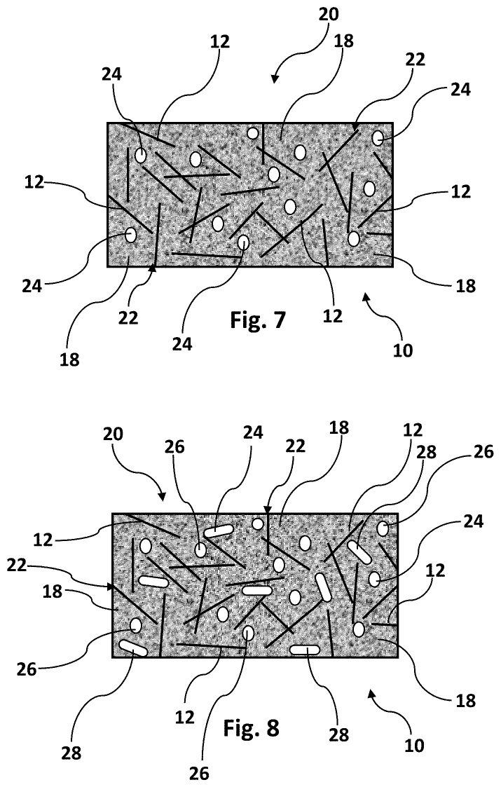

FIG. 7 is a representative cross-sectional view of a portion of another exemplary embodiment showing LCF 12 and a single type of functional additive 24 dispersed throughout the exemplary cementitious base 18 of FIG. 6. Due to the present state of the art, conductive cementitious materials are so heavily loaded to achieve conductivity, viscosity is high and loading other additives is precluded or severely limited. Also, cementitious materials having electrostatic discharge or shielding capability that use the present state of the art, are expensive, complex to make, difficult to replicate, thick, and frequently unable to receive other functional additive 24 loading.

However, the system 10 of the present disclosure provides more efficient, cost-effective, efficacious electrically conductive cementitious materials 20 with a range of replicable electromagnetic properties, lower viscosity, and have multifunctional capabilities while providing desired electromagnetic properties. Introducing a dispersal of LCF 12 into the cementitious base 18 yields an electrically conductive cementitious material 20 having desired electromagnetic properties over a full electromagnetic range (10⁸ to 10⁻³ ohm-cms), including electrostatic dissipation, electrostatic discharge, and shielding with lower loadings of LCF 12 that reduces viscosity and the additional unloaded portion of the electrically conductive cementitious material 20 may now receive other multifunctional materials (functional additives 24).

FIG. 8 is a representative cross-sectional view of a portion of yet another exemplary embodiment showing LCF 12 dispersed throughout the exemplary cementitious base 18 of FIG. 6 with multiple functional additives 24 (for example, a first additive 26 and a second additive 28) also dispersed therein.

Also, because the desired electromagnetic properties, such as electrostatic dissipation, electrostatic discharge, and shielding, can be achieved at lower loads and lower viscosity, the exemplary cementitious materials 20 of the present disclosure may have robust functionality. Other particles may be loaded as functional additives 24 giving the cementitious materials 20 other functions. By way of example only, and not to be construed as limiting, functional additives 24 such as coloring particles, hardening agents such as silicon carbide, lubricating agents, conductive filamentary structures (as defined and described in co-pending U.S. application Ser. No. 16/601,095 filed Oct. 14, 2019, such definition and description being expressly incorporated herein by this reference), and magnetic particles have room in the matrix so that one or more functional additives 24 may be added to the extent that they do not functionally reduce the desired conductivity. Hence, colors of such cementitious materials 20 now may be achieved across a broader spectrum of colors and may be more vibrant. The cementitious materials 20 may harden faster and exhibit greater hardness and wear resistance. Also, other desirable functions now may be exhibited in the cementitious materials 20 without functionally sacrificing the needed conductivity.

As depicted in FIG. 8 as an example of a first additive 26 and a second additive 28, multiple functional additives 24 may be added to the cementitious base 18 so long as there remains room within the cementitious base 18 and the first additive 26 or second additive 28 or any other additional additive 24 does not sacrifice the needed conductivity.

Interrelated methods are used to achieve a desired conductivity that will cause the cementitious materials 20 to manifest the desired electromagnetic properties. Those skilled in the art of electron transport through materials, armed with this disclosure, intuitively and readily can determine and fine tune the interrelationships of the components to achieve the desired electromagnetic properties to be exhibited by the cementitious materials 20 through known empirical means, and without undue experimentation.

For exemplary methods or processes of the invention, the sequence and/or arrangement of steps described herein are illustrative and not restrictive. Accordingly, although steps of various processes or methods may be shown and described as being in a sequence or temporal arrangement, the steps of any such processes or methods are not limited to being carried out in any specific sequence or arrangement, absent an indication otherwise. Indeed, the steps in such processes or methods generally may be carried out in different sequences and arrangements while still falling within the scope of the present invention.

Additionally, any references to advantages, benefits, unexpected results, preferred materials, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under Section 112 is not intended. Additionally, it is not intended that the scope of patent protection afforded the present invention be defined by reading into any claim a limitation found herein that does not explicitly appear in the claim itself.

While specific embodiments and applications of the present invention have been described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Those skilled in the art will appreciate that the present embodiments may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A conductive cementitious material comprising:
a plurality of metal-coated fibers, the metal-coated fibers comprise a fibrous substrate and a metal coating and the metal-coated fibers being chopped to lengths of 0.125 inches to 0.5 inches; and
a cementitious material base, the metal-coated fibers being dispersed throughout the cementitious material base to a load level of between 0.01% to 2% by weight such that the conductivity of the conductive cementitious material ranges from 10⁸ to 10⁻³ ohm-cm.

2. The conductive cementitious material of claim 1 wherein the fibers of the metal-coated fibers are selected from the group of fibers consisting of carbon fiber, cellulose fiber, cotton fiber, natural fibers, Kevlar, rayon, synthetic fibers, and nanofibers.

3. The conductive cementitious material of claim 1 wherein the metal coating comprises nickel.

4. The conductive cementitious material of claim 3 wherein the nickel metal coating comprises 15% to 50% of the metal-coated fibers by weight.

5. The conductive cementitious material of claim 3 wherein the nickel metal coating comprises 15% to 30% of the metal-coated fibers by weight.

6. The conductive cementitious material of claim 3 further comprising a functional additive.

7. The conductive cementitious material of claim 6 wherein the functional additive is selected from the group of functional additives consisting of coloring particles, hardening agents, lubricating agents, magnetic particles, and any combination of such additives.

8. The conductive cementitious material of claim 1 wherein the metal-coated fibers are chopped to the length of 0.25 inches.

9. The conductive cementitious material of claim 1 wherein the load level of the metal-coated fibers dispersed throughout the cementitious material base ranges between 0.125% and 0.5% by weight provides ESD.

10. The conductive cementitious material of claim 1 wherein the load level of the metal-coated fibers dispersed throughout the cementitious material base ranges between 1% and 2% by weight provides shielding against EMI.

11. The conductive cementitious material of claim 1 wherein the load level of the metal-coated fibers dispersed throughout the cementitious material base ranges between 1% and 2% by weight provides controlled heating of the conductive cementitious material with the application of an electrical current.

12. A multifunctional, conductive cementitious material comprising:
a plurality of metal-coated fibers, the metal-coated fibers comprise a fibrous substrate and a metal coating and the metal-coated fibers being chopped to lengths of 0.125 inches to 0.5 inches;
a functional additive, and
a cementitious material base, the metal-coated fibers being dispersed throughout the cementitious material base to a load level of between 0.01% to 2% by weight such that the conductivity of the conductive cementitious material ranges from 10⁸ to 10⁻³ ohm-cm.

13. The multifunctional, conductive cementitious material of claim 12 wherein the fibers of the metal-coated fibers are selected from the group of fibers consisting of carbon fiber, cellulose fiber, cotton fiber, natural fibers, Kevlar, rayon, synthetic fibers, and nanofibers.

14. The multifunctional, conductive cementitious material of claim 12 wherein the metal coating comprises nickel, and the nickel metal coating comprises 15% to 50% of the metal-coated fibers by weight.

15. The multifunctional, conductive cementitious material of claim 14 wherein the nickel metal coating comprises 15% to 30% of the metal-coated fibers by weight.

16. The multifunctional, conductive cementitious material of claim 12 wherein the metal-coated fibers are chopped to the length of 0.25 inches.

17. The multifunctional, conductive cementitious material of claim 12 wherein the load level of the metal-coated fibers dispersed throughout the cementitious material base ranges between 0.125% and 0.5% by weight provides ESD.

18. The multifunctional, conductive cementitious material of claim 12 wherein the load level of the metal-coated fibers dispersed throughout the cementitious material base ranges between 1% and 2% by weight provides shielding against EMI.

19. The multifunctional, conductive cementitious material of claim 12 wherein the load level of the metal-coated fibers dispersed throughout the cementitious material base ranges between 1% and 2% by weight provides controlled heating of the conductive cementitious material with the application of an electrical current.

20. The multifunctional, conductive cementitious material of claim 12 wherein the functional additive comprises one or more functional additives selected from a group of functional additives consisting of coloring particles, hardening agents, lubricating agents, magnetic particles, and conductive filamentary structures.
